(19) United States
(12) Patent Application Publication
(10) Pub. No.: US 2022/0402711 A1
(43) Pub. Date: Dec. 22, 2022

(54) DOCK LOCK ACCESS DOOR FOR LIFT GATE

(71) Applicant: ANTHONY LIFTGATES, INC., Pontiac, IL (US)

(72) Inventor: Jesse JUSTUS, Pontiac, IL (US)

(21) Appl. No.: 17/843,371

(22) Filed: Jun. 17, 2022

Related U.S. Application Data
(60) Provisional application No. 63/211,938, filed on Jun. 17, 2021.

(51) Int. Cl. B65G 69/28; B60P 1/43; B60P 1/44

(52) U.S. Cl. CPC B65G 69/2876; B60P 1/435; B60P 1/4492

(57) ABSTRACT

A liftgate load system for use with a vehicle, which includes deck sections that are movable between an in use position where the deck sections form a horizontal platform to a stowed position where the deck sections are folded a vertical arrangement. The liftgate load system also includes an adapter on the platform that is provided with a door that is movable between a closed position and an open position and backing plate that is configured to be engaged by a dock lock hook of a loading dock to limit movement of the lift system away from the loading dock. The door is configured to move from the cover position to the open position as the load platform moves from the use position to the stowed position.

### PRIORITY CLAIM

This application claims priority under 35 U.S.C. § 119(e) to U.S. Provisional Application Ser. No. 63/211,938, filed Jun. 17, 2021, which is expressly incorporated herein by reference in its entirety.

### BACKGROUND

The present disclosure relates to lift gates and particular to lift gates used on motor vehicles to allow a vehicle operator to load and unload the contents of a trailer onto a loading dock or other platform. The present disclosure also relates to an apparatus to aid in securing the vehicle to the loading dock having a loading dock lock so that the vehicle remains secured to the loading dock during loading and unloading of the vehicle.

### SUMMARY

In accordance with the present disclosure, a dock lock access door is shown as part of a lift gate system.

In illustrative embodiments, the lift gate system is used in connection with a motor vehicle and includes a pair of spaced apart rails configured to be coupled to the vehicle. The lift system also includes a load platform that is provided with a first deck section that is coupled to the rails and a second deck section that is pivotably coupled to the first deck section.

In illustrative embodiments, the load platform, which includes the deck sections, is movable between an in use position where the second deck section extends from the first deck section to form a horizontal platform and a stowed position where the first and second deck sections are folded next to each other in a vertical arrangement. The lift system also includes an adapter that is coupled to the first deck section. The adapter includes a door that is coupled to the first deck section and further includes a backing plate. The door is movable between a closed position and an open position. The backing plate is configured to be engaged by a lock mechanism of a loading dock to block movement of the lift system away from the loading dock. The door is configured to move from the cover position to the open position as the load platform moves from the use position to the stowed position.

In illustrative embodiments, the lift system further includes a pusher that is coupled to the second deck section. The pusher is configured to move the door from the closed position to an open position. The pusher engages a pair of arms that extend outwardly from the door. Movement of the lift gate from the open position to the closed position causes the pusher to engage the arms of the door and move the door from the closed position to the open position to allow a dock hook to engage the backing plate.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a is a perspective view of a vehicle lift gate connected to a vehicle;

FIG. 2 is a perspective view of a bottom of the vehicle lift gate;

FIG. 3 is a perspective view of a dock lock mechanism;

FIG. 4 is a perspective view of the first and second deck sections of the lift platform;

FIG. 5 is a side elevational view of the lift platform showing the first and second deck sections in the horizontal, in use, position;

FIG. 6 is a side elevational view of the lift platform in the folded, stored position;

FIG. 7 is a perspective view of the rear side of the vehicle lift gate showing the first lift platform folded up against the vehicle and oriented in a vertical position;

FIG. 8 is a perspective view of the lift platform showing first and second lift platforms in a partially open position and also illustrating pusher member aligned with first and second arms;

FIG. 9 is a perspective view of the first lift platform showing the access door pivoted to the open position and exposing the backing plate;

FIG. 10 is a perspective view of the lift platform showing first and second lift platforms in a partially open position;

FIG. 11 is a rear perspective view of the lift platform with the first, second and third lift platforms in the extended, in use position; and

FIG. 12 is a front perspective view of the lift platform with the first, second and third lift platforms in the extended, in use position.

### DETAILED DESCRIPTION

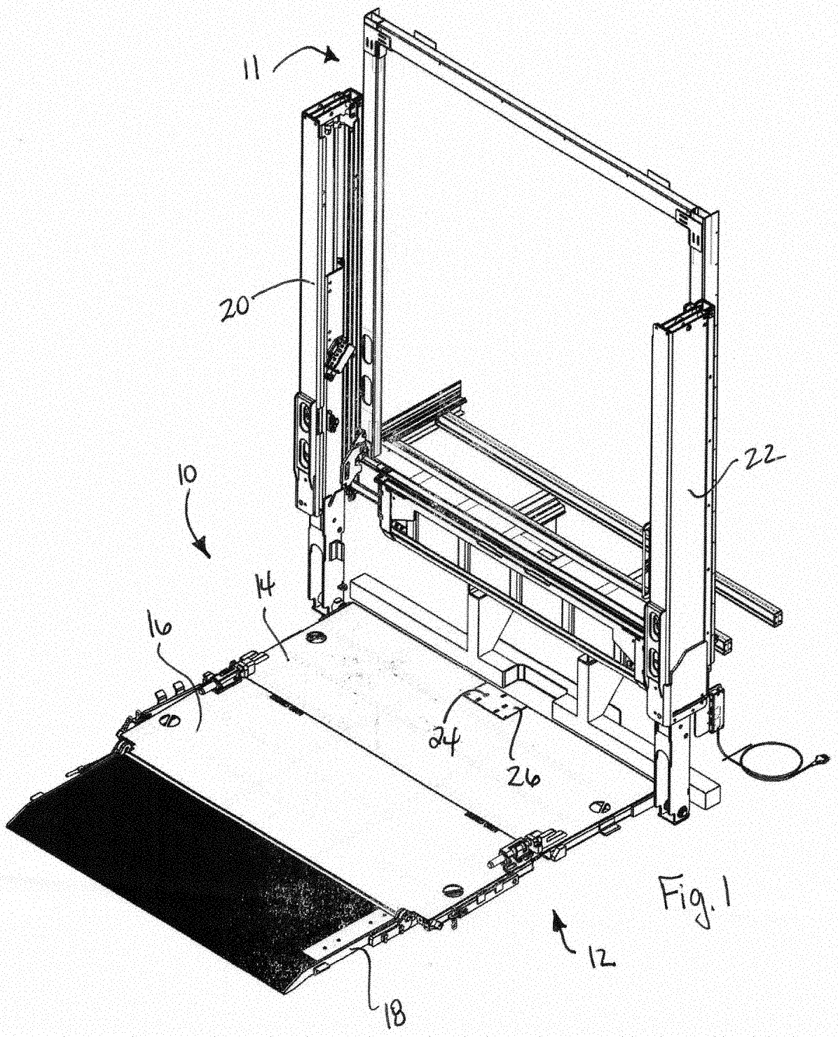

In illustrative embodiments, a vehicle lift gate 10 is shown connected to a vehicle 11 that includes a lift platform 12 having a first deck section 14, a second deck section 16 that is pivotally connected to the first deck section 14 and a third deck section 18 that pivotally connected to the second deck section 16, as shown in FIG. 1. Deck sections 14, 16, and 18, when unfolded in the in-use position, form the lift platform 12, which can be used to load and unload cargo from the bed of the vehicle 11. First deck section 14 is pivotally connected to a pair of vertical supports 20, 22 that are adapted to raise and lower the platform 12 so cargo can be lowered from the truck bed to a ground level. First deck section 14 of platform 12 includes a dock lock access 24. Dock lock assembly 24 includes an access door 26 that is pivotally coupled to the first deck section 14. Access door 26 of dock lock assembly 24 is configured to be in a closed horizontal orientation and flush with a top surface 28 of first deck section 14 when lift platform 12 is in the horizontal, in use position. Dock lock assembly 24 allows a loading dock lock hook 38 to be secured to the vehicle liftgate 10 to prevent the vehicle from rolling away while unloading or loading the vehicle from the dock.

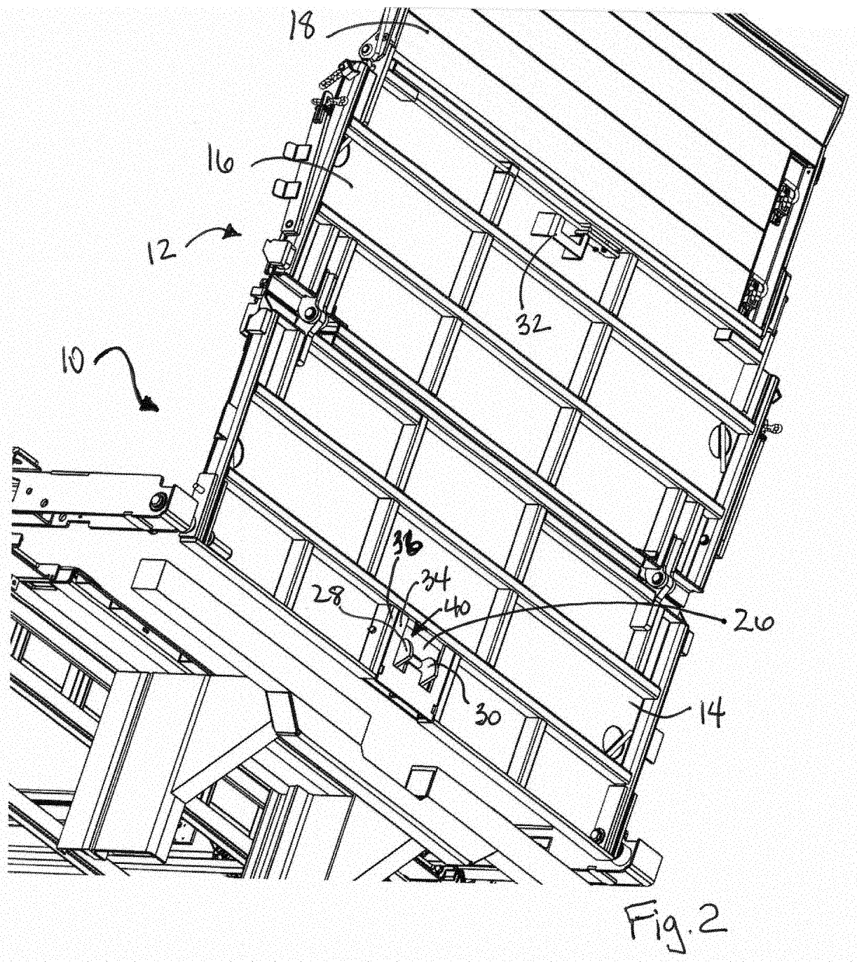

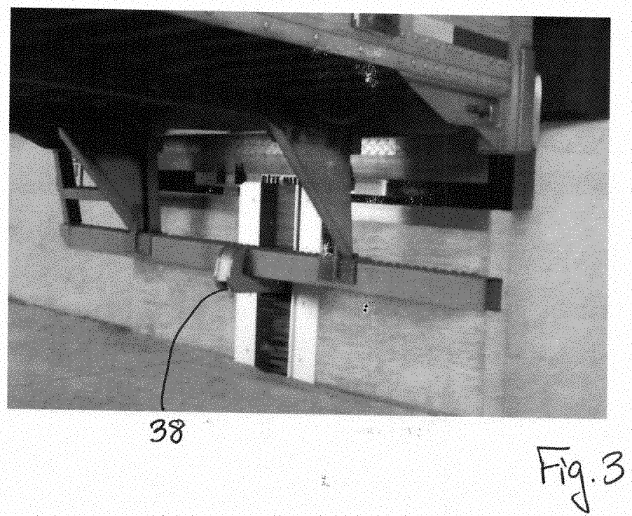

FIG. 2 is a perspective view of a bottom side of the vehicle lift platform 12, showing the first, second, and third deck sections 14, 16, 18 in an unfolded in-use position. While a three section lift platform is shown, a lift platform with only a first and a second deck section could also be used. First deck section 14 includes an opening 36 formed in the first deck section 14 proximate an edge closest to the vehicle 11. Opening 36 includes access door 26 that is pivotally coupled to the first deck section 14 by use of a hinge pin 46 to create an axis of rotation. Opening 36 also includes backing plate 34 that is secured to the first deck section 14. Backing plate 34 provides a latch surface for a dock lock hook 38 to engage, as shown in FIG. 3, for example. When the liftgate is folded and the vehicle is backed up to a loading dock, the dock lock hook 38 on the loading dock can engage and lock onto the backing plate 34 to prevent the vehicle from rolling away. Access door 26 includes a pair of arms 28, 30 that extend outwardly from door 26, as shown in FIG. 2.

Arms 28, 30 of access door 26 are adapted to engage pusher member 32 when the lift platform 12 is in the folded position and second deck section 16 is positioned adjacent first deck section 14 when folded and in a vertical orientation. Pusher member 32 is coupled to the underside of second deck section 16 near the edge of second deck section 16 proximate third deck section 18. Backing plate 34 is formed to include an opening 40 that allows for the arms 28, 30 to extend through.

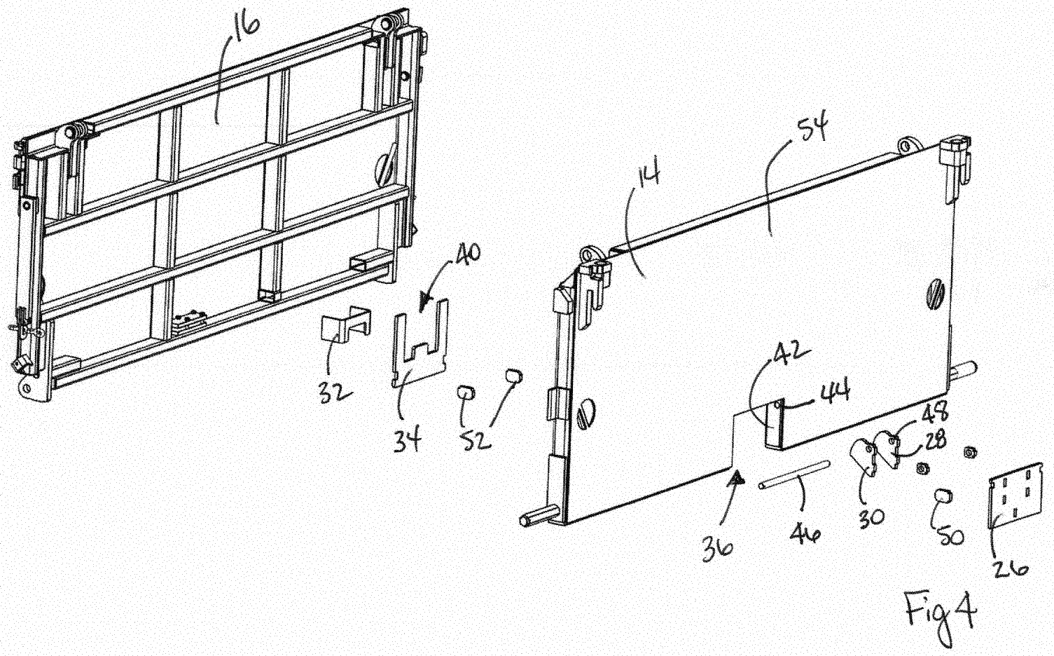

FIG. 4 is a perspective view of the first and second deck sections 14, 16 of the lift platform 12 with the dock lock access 24 shown in an exploded view. First deck section 14 includes opening 36 that is adapted to accept dock lock assembly 24. Opening 36 includes side walls 42 that are formed to include apertures 44 that are configured to accept hinge pin 46. Arms 28, 30 of access door 26 includes apertures 48 that are configured to accept hinge pin 46 to allow access door 26 to rotate with respect to deck section 14.

Access door 26 includes a stop member 50 that is configured to engage backing plate 34 when access door 26 is in the closed position to limit the downward travel of the access door 26 so that the access door 26 is flush with an upper surface 54 of the first deck section 14. Backing plate 34 includes two additional stop member 52 that provide support for access door 26 when access door 26 is in the closed position. Backing plate 34 includes the opening 40 that allows for the passage of arms 28 and 30 when access door 26 is in the closed position. Access opening 40 also allows for the passage of pusher member 32 through opening 40 to push access door 26 to the open position. In the open position, access door 26 is generally perpendicular to upper surface 54 of first deck section 14 but enough so that dock lock hook 38 can engage with backing plate 34. Arms 28, 30 and stop member 50 are secured to access door 26 preferably by welding, but other attachment means could also be used. Backing plate 34 is secured to first deck section 14 and pusher member 32 is secured to second deck section 16 preferably by welding, but other attachment means know to those skilled in the art could also be used.

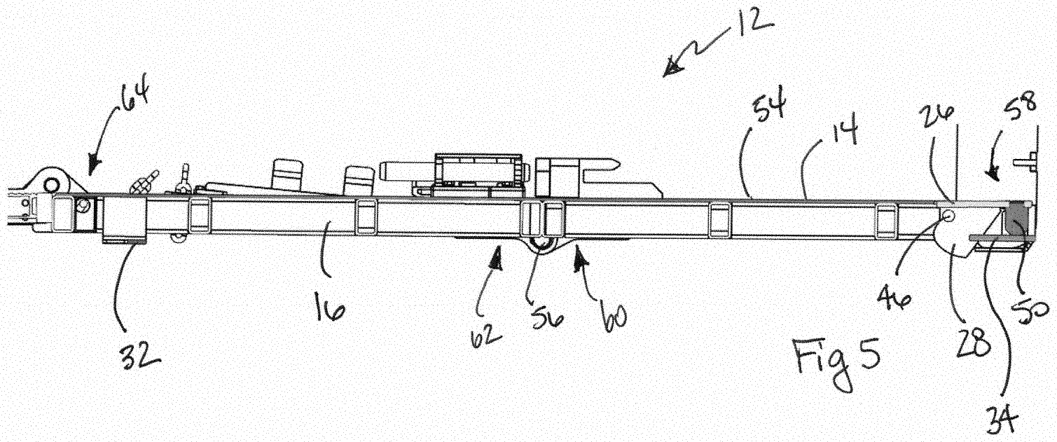

FIG. 5 is a side elevational view of the lift platform 12 showing the first and second deck sections 14, 16 in the horizontal, in use, position. Second deck section 16 is pivotally coupled to first deck section 14 by use of hinge 56. Access door 26 is shown in the closed position, flush with upper surface 54 of the first deck section 14 and blocking opening 36 in the first deck section 14 so that the foot of an operator or the wheel or caster from a hand truck or other device used to load and unload cargo from the vehicle does not get stuck in the opening 36.

In this position, arms 28, 30 of access door 26 extend through opening 40 of backing plate 34. Pusher member 32 of second deck section 16 is spaced apart from access door 26 when the lift platform 12 is in the use position. Access door 26 is located at a first end 58 of the first deck section 14. First deck section 14 is hinged to the second deck section 16 at a second end 60. Second deck section 16 includes a first end 62 and a spaced apart second end 64. Pusher member 32 is located at second end 64 of second deck section 16. Pusher member 32 is secured to section deck section 16 at a location that allows pusher member 32 to engage arms 28, 30 of access door 16 so that pusher member 32 can cause access door 26 to open when the lift platform 12 is in the folded and stored position.

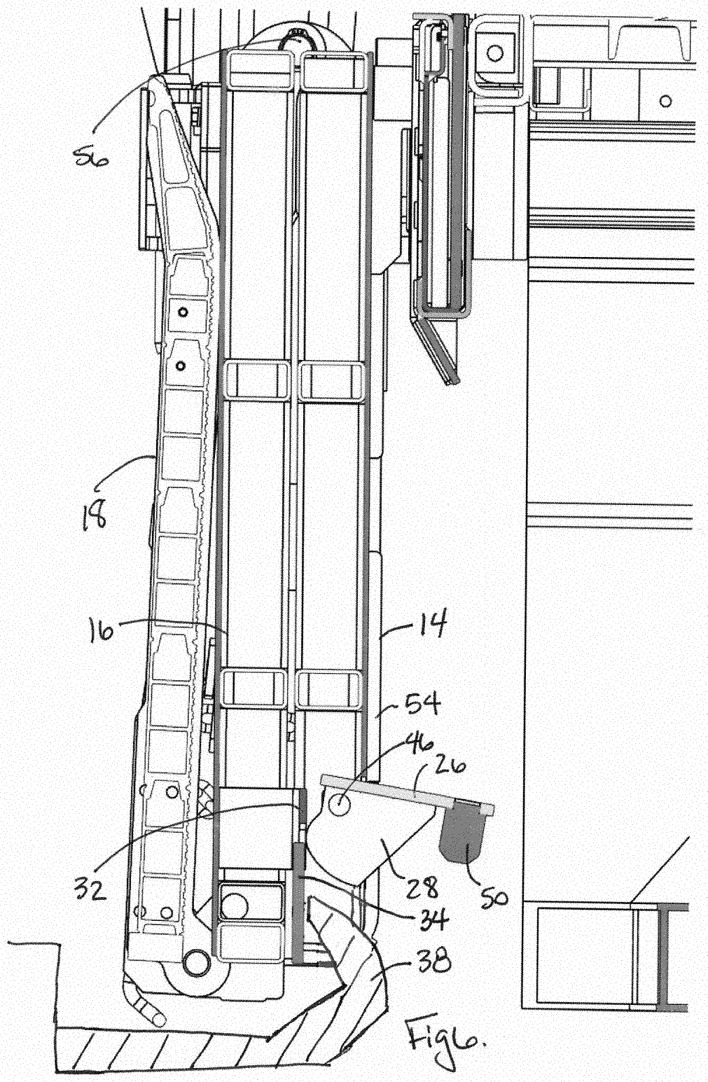

FIG. 6 is a side elevational view of the lift platform 12 in the folded, stored position. In the stored position, first and second deck sections 14, 16 are vertically oriented and abutting one another. In this position, pusher member 32 engages arms 28, 30 of access door 26 to push access door 26 to an open position so that the access door 26 is generally perpendicular to upper surface 54 of first deck section 14. When access door 26 is in the open position, a space is created to allow dock lock hook 38 to engage backing plate 34 to prevent unwanted movement of the vehicle with respect to the loading dock.

Dock lock hooks 38 installed on delivery docks may not be long enough to engage with a lift gate due to the thickness of the lift gate when folded into the stored position. With the platform sections in the folded position, the access door 2 is in the open position, reducing the overall thickness of the liftgate sections where the dock lock hook 38 engages with the liftgate. With access door 26 in the open position and out of the way the overall thickness profile of the lift platform 12 is reduced when in the folded position, allowing the dock lock hook 38 to engage the lift platform 12 and secure the vehicle to prevent unwanted movement. Access door 26 is designed so that, in the event the lift platform 12 is raised when in the stored position, arms 28, 30 of access door 26 would push on pusher member 32, which would cause second and third lift platforms 16, 18 to rotate away from first lift platform 14 about hinge 56. This prevents damage to the access door 26. Lowering platform would cause the weight of second and third lift platforms 16, 18 to push pusher member 32 against arms 28, 30 to move access door 26 back to the open position.

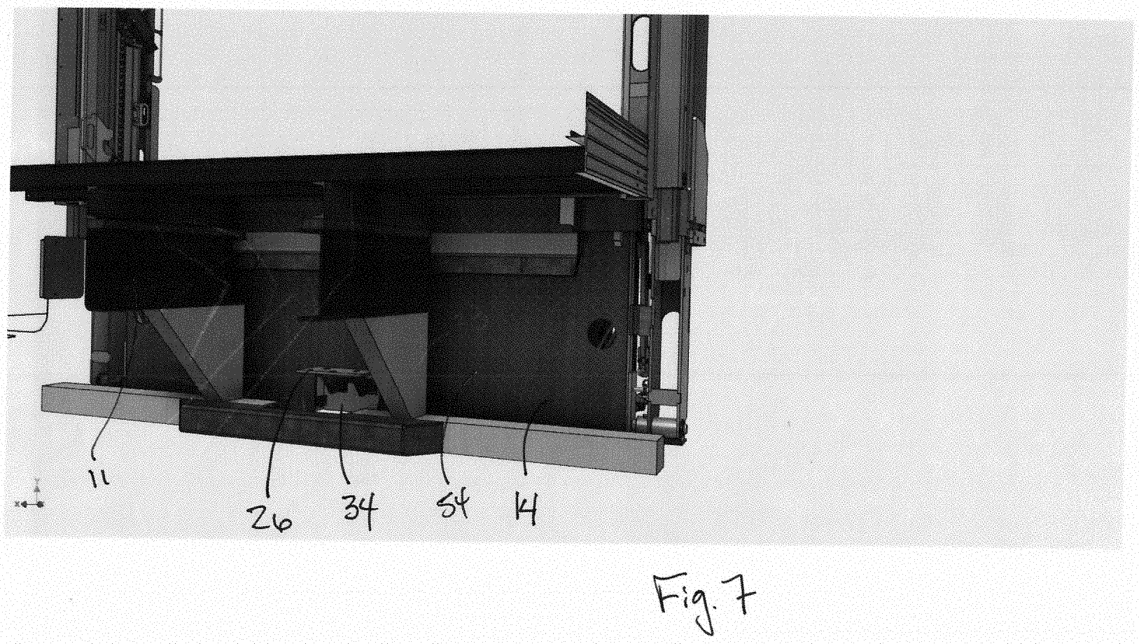

FIG. 7 is a perspective view of the rear side of the vehicle lift gate 10 showing the first lift platform 14 folded up against the vehicle 11 and oriented in a vertical position. The first lift platform 14 includes the access door 26 extending outwardly from an upper surface 54 exposing the backing plate 34. With the access door 26 in the open position, a dock lock hook 38 can engage with the backing plate 34 to secure the vehicle 11 to the loading dock to prevent unwanted movement.

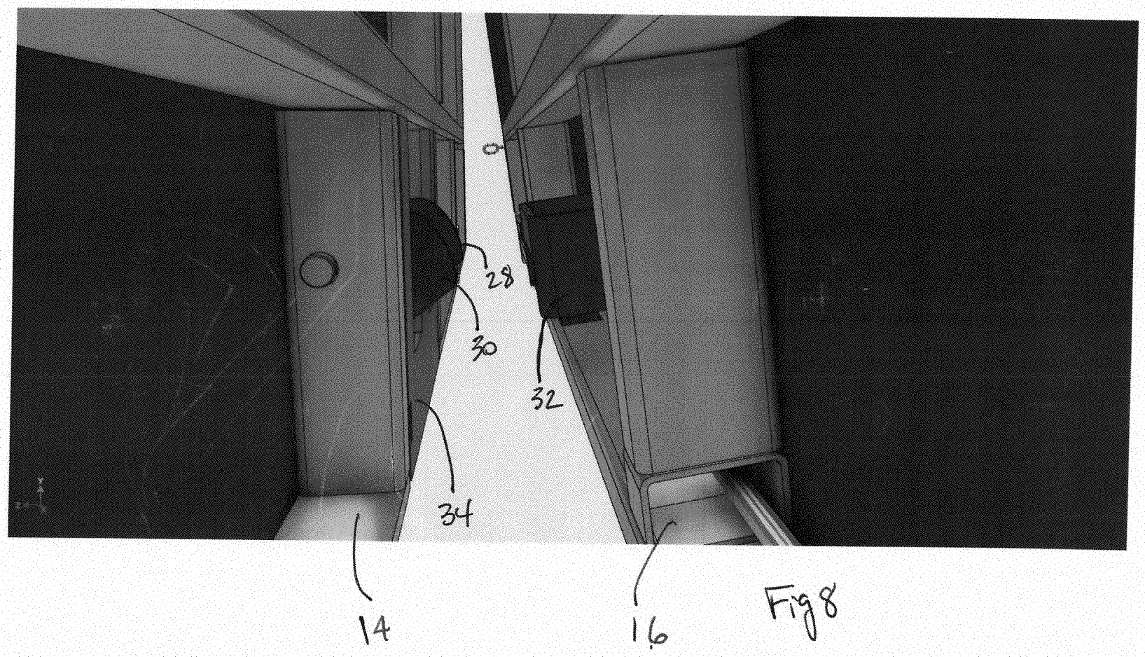

FIG. 8 is a perspective view of the lift platform 12 showing first and second lift platforms 14, 16 in a partially open position and also illustrating pusher member 32 aligned with first and second arms 28, 30. Continued movement of first and second lift platforms 14, 16 to a closed position will cause pusher member 32 to engage and push arms 28, 30, which, in turn, will pivot access door 26 to the open position.

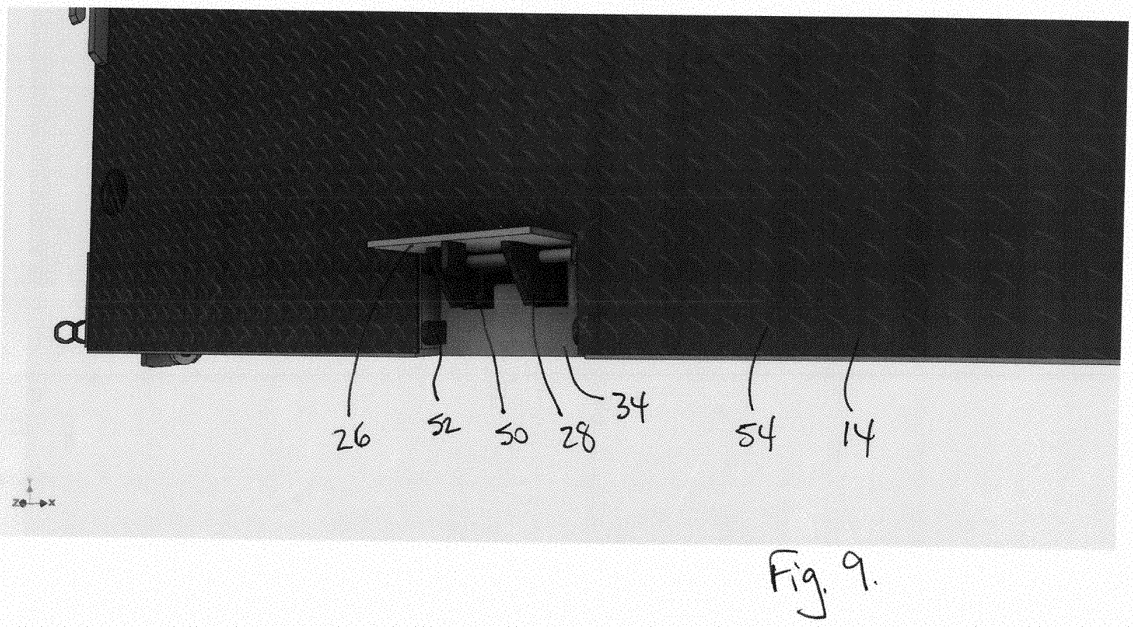

FIG. 9 is a perspective view of the first lift platform 14 showing the access door 26 pivoted to the open position and exposing the backing plate 34 that is to be engaged by the dock lock hook 38 to secure the vehicle 11.

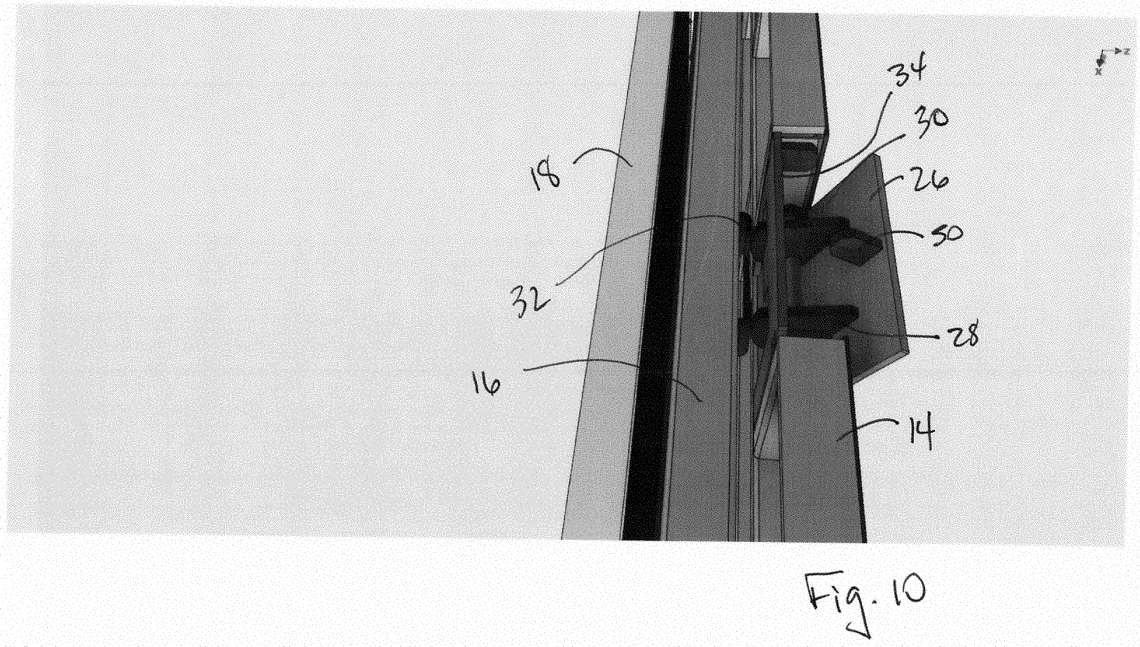

FIG. 10 is a perspective view of the lift platform 12 showing first and second lift platforms 14, 16 in a partially open position and also illustrating pusher member 32 aligned with and pushing first and second arms 28, 30 to open access door 26. Continued movement of first and second lift platforms 14, 16 to a closed position will cause pusher member 32 to further engage and push arms 28, 30, which, in turn, will fully pivot access door 26 to the open position.

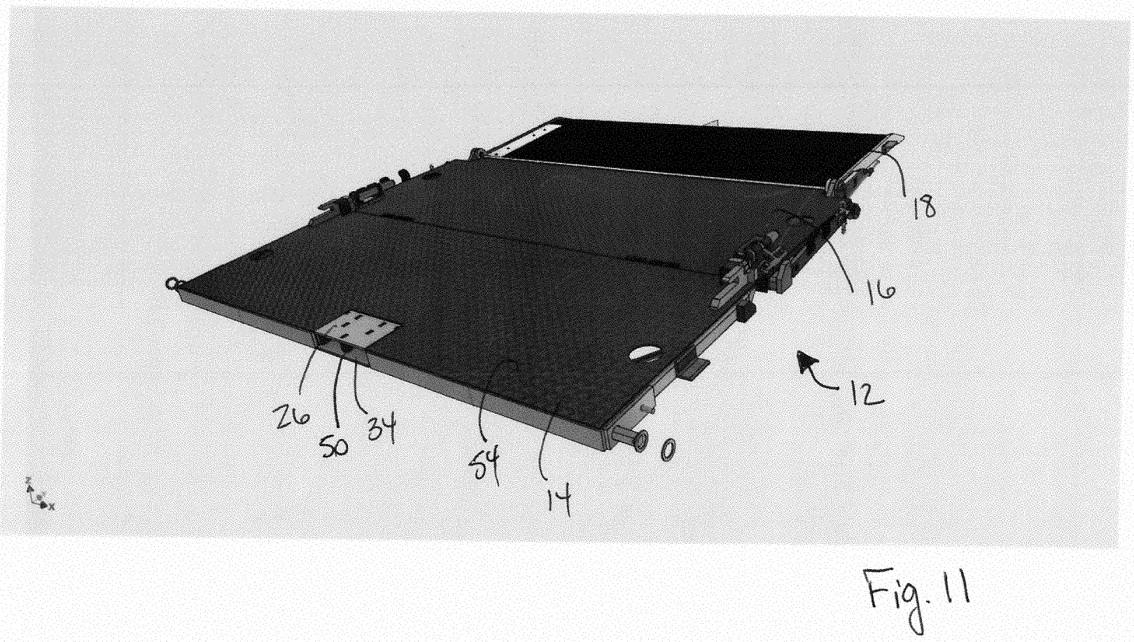

FIG. 11 is a perspective view of the lift platform 12 with the first, second and third lift platforms 14, 16, 18 in the extended, in use position. All three lift platforms are in a horizontal position. With the lift platforms in the horizontal position, the access door 26 is in the closed position and is flush with the upper surface 54 of the first deck section 14 to cover the opening formed in the first deck section.

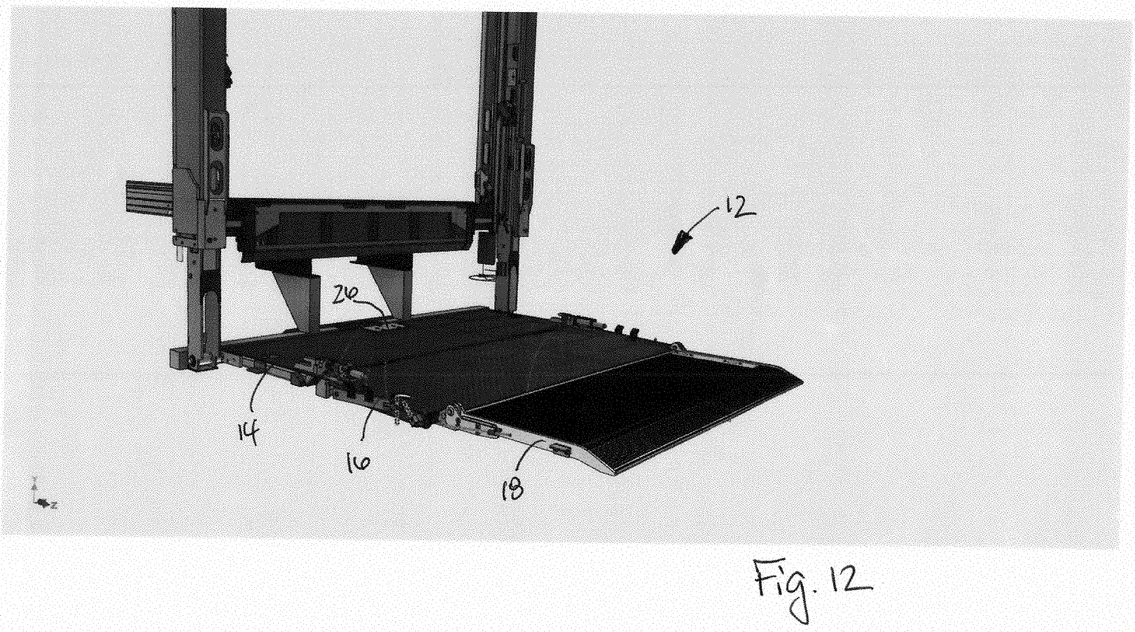

FIG. 12 is a perspective view of the lift platform 12 with the first, second and third lift platforms 14, 16, 18 in the extended, in use position. All three lift platforms are in a horizontal position. With the lift platforms in the horizontal position, the access door 26 is in the closed position and is flush with the upper surface 54 of the first deck section 14 to cover the opening formed in the first deck section.

Various features of the invention have been particularly shown and described in connection with the illustrative embodiment of the invention, however, it must be understood that these particular arrangements may merely illustrate, and that the invention is to be given its fullest interpretation within the terms of the appended claims.

What is claimed is:

1. A lift system for use with a motor vehicle comprising:
a pair of spaced apart rails configured to be coupled to the vehicle;
a load platform including a first deck section coupled to the rails and a second deck section pivotably coupled to the first deck section, the load platform movable between a use position where the second deck section extends from the first deck section and a stowed position where the second deck section extends along the first deck section; and
an adapter coupled to the first deck section, the adapter including a door coupled to the first deck section and a backing plate;
wherein the door is movable between a closed position and an open position, the backing plate is configured for engagement with a lock mechanism of a loading dock to block movement of the vehicle away from the loading dock, and the door is configured to move from the cover position to the open position as the load platform moves from the use position to the stowed position.

2. The lift system of claim 1 further including a pusher coupled to the second deck section, the pusher is configured to move the door from a closed position to an open position.

3. The lift system of claim 2, wherein the adapter further includes a backing plate that is configured to accept the locking mechanism.

4. The lift system of claim 3, wherein the backing plate is formed to include an opening configured to allow for the passage of at least a portion of the pusher.

5. The lift system of claim 1, wherein the door includes a first side and a second side wherein the second side includes an outwardly extending arm.

6. The lift system of claim 5, further including a pusher coupled to the second deck section, the pusher is configured to engage the arm of the door to move the door from a closed position to an open position.

7. A liftgate system for use with a motor vehicle and used to secure the vehicle to a dock lock of a loading dock, the liftgate system comprising:
a liftgate mount configured to be coupled to the motor vehicle;
a load platform including a first deck section coupled to the liftgate mount and a second deck section pivotably coupled to the first deck section, the load platform movable between a use position where the second deck section extends from the first deck section so that the deck sections are generally horizontally oriented and a stowed position where the second deck section extends along the first deck section such that the deck sections are generally vertically oriented;
a dock lock adapter coupled to the first deck section, the dock lock adapter including a door movable with respect to the first deck section;
wherein the door is movable between a closed position and an open position, the dock lock adapter is configured for engagement with the dock lock of the loading dock to limit movement of the vehicle away from the loading dock.

8. The liftgate system of claim 7, wherein the door is configured to move from the cover position to the open position as the load platform moves from the use position to the stowed position.

9. The liftgate system of claim 8, wherein the dock lock adapter includes a backing plate configured to engage with the dock lock of the loading dock to limit movement of the vehicle.

10. The liftgate system of claim 9, further including a pusher coupled to the second deck section, the pusher is configured to move the door from a closed position to an open position.

11. The liftgate system of claim 10, where the pusher engages the door when the deck sections are in the stowed position.

12. The liftgate system of claim 11, wherein the backing plate is formed to include an opening configured to allow for the passage of at least a portion of the pusher.

13. The liftgate system of claim 7, wherein the door includes a first side and a second side wherein the second side includes an outwardly extending arm.

14. The liftgate system of claim 13, further including a pusher coupled to the second deck section, the pusher is configured to engage the arm of the door to move the door from a closed position to an open position.

15. The liftgate system of claim 13, wherein at least a portion of the arm is configured to pass through the opening of the backing plate.

16. A liftgate for use with a vehicle that can be secured to a dock lock of a loading dock, the liftgate comprising:
a mount configured for securing the liftgate to the vehicle;
a lift platform coupled to the mount for vertical movement on the mount, the lift platform including a first deck section and a second deck section pivotally connected to the first deck section, the lift platform having a first in use position where the deck sections are in a generally horizontal configuration and a storage position where the deck sections are in a generally horizontal configuration;
a dock lock assembly adapted to be coupled to one of the deck sections the lock dock lock assembly including a door wherein the door is movable between a closed position and an open position, the dock lock assembly is configured for engagement with the dock lock of the loading dock when the door is in the open position to limit movement of the vehicle away from the loading dock.

17. The liftgate system of claim 16, wherein the door is configured to move from the closed position to the open position as the load platform moves from the use position to the storage position.

18. The liftgate system of claim 16, wherein the dock lock assembly includes a backing plate configured to engage with the dock lock of the loading dock to limit movement of the vehicle.

19. The liftgate system of claim 16, further including a pusher coupled to the other of the deck sections, the pusher is configured to move the door from a closed position to an open position when the lift platform is moved from the in use position to the storage position.

20. The liftgate system of claim 19, wherein the door includes a first side and a second side wherein the second side includes an outwardly extending arm that is configured to engage with the pusher to move the door from the closed position to the open position.
